(19) United States
(12) Patent Application Publication
(10) Pub. No.: US 2008/0171513 A1
(43) Pub. Date: Jul. 17, 2008

(54) Bluetooth wireless phone with touchpad

(75) Inventor: Chi-Liang Lin, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/987,230

(22) Filed: Nov. 28, 2007

(30) Foreign Application Priority Data
Jan. 11, 2007 (TW) 96101106

(51) Int. Cl. H04B 7/00

(52) U.S. Cl. 455/41.2

(57) ABSTRACT

A Bluetooth wireless phone includes a Bluetooth communication module, a micro controller unit (MCU) and a touchpad. The Bluetooth communication module includes a Bluetooth transceiver device and a Bluetooth operating unit. A signal connection is performed between the Bluetooth transceiver device and electronic equipment having the ability of sending and receiving Bluetooth signals. The Bluetooth operating unit utilizes at least one specific profile and is electrically connected to the Bluetooth transceiver device. The micro controller unit is electrically connected to the Bluetooth communication module, and the touchpad is electrically connected to the micro controller unit.

### BACKGROUND OF THE INVENTION

This Non-provisional application claims priority under U.S.C.§119(a) on Patent Application No(s). 096101106, filed in Taiwan, Republic of China on Jan. 11, 2007, the entire contents of which are hereby incorporated by reference.

### FIELD OF THE INVENTION

The present invention relates to a Bluetooth wireless phone, and more particularly to a Bluetooth wireless phone utilizing a touch pad to simultaneously control electronic equipment when the Bluetooth wireless phone is in use.

### DESCRIPTION OF THE RELATED ART

With the progress of Internet/networking communication software and the evolution of wireless broadband networking, Internet phones and wireless transmission technology have rapidly developed. The 2.4 GHz-nonstandard specification for wireless fidelity (WIFI), local area network/wireless LAN (WLAN), and Bluetooth are three main categories in the wireless transmission technology. Because the high frequency transmission provided by Bluetooth wireless transmission tends not to be interfered with, data such as image and voice data can be transmitted at a very high speed over a short distance. The related equipment is lightweight, low power consumption and multimedia capable, and thus the potential for a viable wireless network phone exists.

FIG. 1 is a block diagram depicting the operation of a conventional Bluetooth wireless phone 1. The Bluetooth wireless phone 1 is instituted by a Bluetooth communication module 11, a micro controller unit 12 and a memory 121. The Bluetooth communication module 11 is instituted by a headset profile 1111, a serial port profile 1112 and a Bluetooth transceiver element 112.

When the Bluetooth wireless phone 1 is in use, a desktop computer 13 connected to Internet 14 is connected to the Bluetooth transceiver element 112. The Bluetooth transceiver element 112 receives signals transmitted from the desktop computer 13 via network communication software installed in the desktop computer 13, and the signals transmitted from the Bluetooth transceiver element 112 are transmitted to the micro controller unit 12 via the serial port profile 1112. Signals processed by the micro controller unit 12 are temporarily stored in a cache of the memory 121. User vocal data is processed by the headset profile 1111 and transmitted to the desktop computer 13 via the Bluetooth transceiver element 112. Thus, the Bluetooth wireless phone 1 can achieve audio communication between two users.

The Bluetooth wireless phone 1 in use is often incorporated with the desktop computer 13. However, the Bluetooth wireless phone 1 cannot remotely control the desktop computer 13 and must be placed near the desktop computer 13 and controlled by an input device, such as a mouse. Besides, when the video/audio function of the Bluetooth wireless phone 1 is in use, users can not be able to readily select new music or control the volume.

### BRIEF SUMMARY OF THE INVENTION

The present invention provides a Bluetooth wireless phone with a touchpad and hot keys for remote control of electronic equipment and multimedia thereof, thus decreasing the number of accessories, simplifying the structure by using the same power supply and increasing usability in related fields.

An embodiment of the Bluetooth wireless phone includes a Bluetooth communication module, a micro controller unit and a touchpad. The Bluetooth communication module includes a Bluetooth transceiver device and a Bluetooth operating unit. The Bluetooth transceiver device is communicated with electronic equipment having the ability of sending and receiving Bluetooth signals. The Bluetooth operating unit utilizes at least one specific profile and is electrically connected to the Bluetooth transceiver device. The micro controller unit is electrically connected to the Bluetooth communication module, and the touchpad is electrically connected to the micro controller unit.

The Bluetooth wireless phone may further include a front surface and a rear surface opposite the front surface. The touchpad is disposed on the rear surface. The Bluetooth wireless phone may further include a plurality of hot keys disposed on the rear surface. Each hot key corresponds to at least one specific profile suitable for video, music or other multimedia. A planar display module may further be disposed on the front surface of the Bluetooth wireless phone. A plurality of keys for dialing are disposed on the front surface of the Bluetooth wireless phone. The planar display module can be a liquid display module, organic light-emitting display module or a light-emitting diode display module. The Bluetooth wireless phone can further include a laser light source for pointing.

The touchpad can induce and record a plane coordinate, and the Bluetooth transceiver device emits a radio wave corresponding to the plane coordinate. The electronic equipment includes a cursor controlled by the radio wave. The Bluetooth wireless phone can further include a universal asynchronous receiver and transceiver (UART) or an inter-integrated circuit (I2C) serial bus to transmit signals between the Bluetooth communication module and the micro controller unit. The at least one specific profile can include a hands-free profile, an advance audio distribution profile, a human-interface operation profile, an audio and video frequency remote control profile or other profiles. The electronic equipment can be a desktop or laptop computer. The Bluetooth wireless phone can further include a speaker/microphone to play/record voice data. The Bluetooth wireless phone is incorporated with electronic equipment installed with a network voice communication software, so as to perform a voice data communication therebetween via the network voice communication software.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block diagram depicting the operation of a conventional Bluetooth wireless phone;

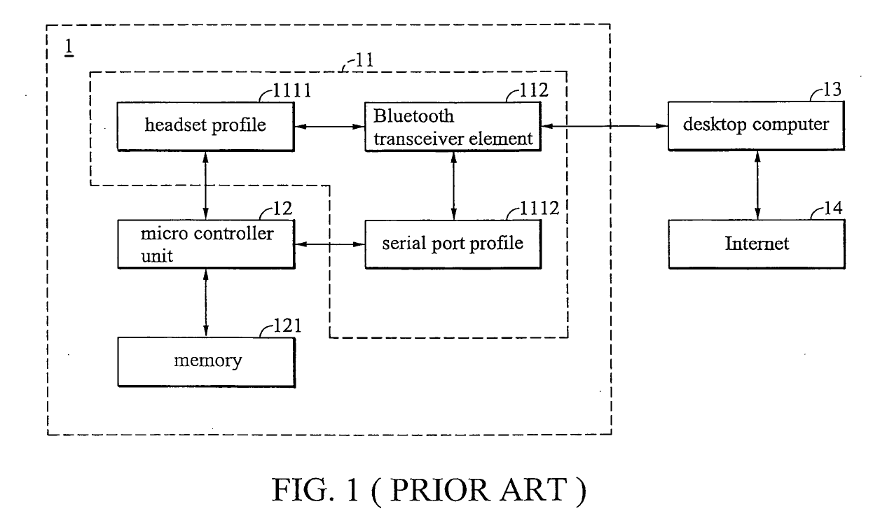

FIG. 2 is a block diagram depicting the operation of a Bluetooth wireless phone of the present invention;

FIG. 3A is a front perspective view of the Bluetooth wireless phone of FIG. 2; and

FIG. 3B is a rear perspective view of the Bluetooth wireless phone of FIG. 2.

### DETAILED DESCRIPTION OF THE INVENTION

The following description is of the best-contemplated mode of carrying out the present invention. This description is made for the purpose of illustrating the general principles of the present invention and should not be taken in a limiting sense. The scope of the present invention is best determined by reference to the appended claims.

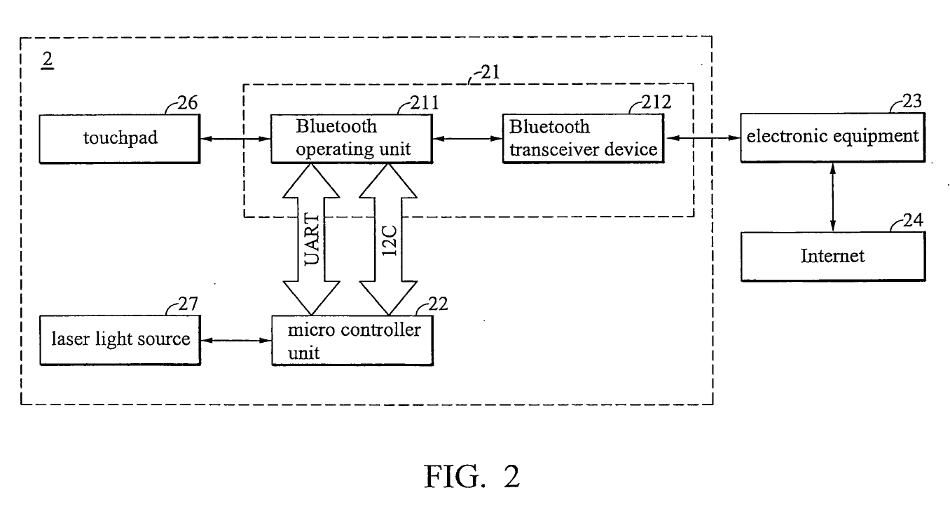

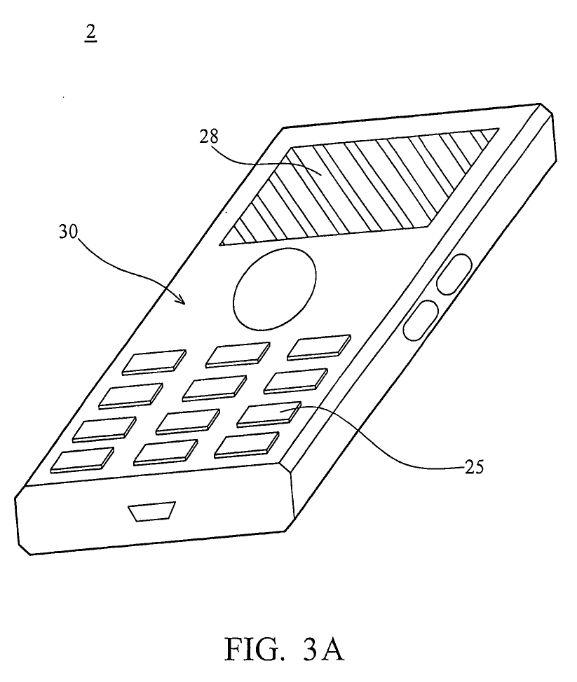

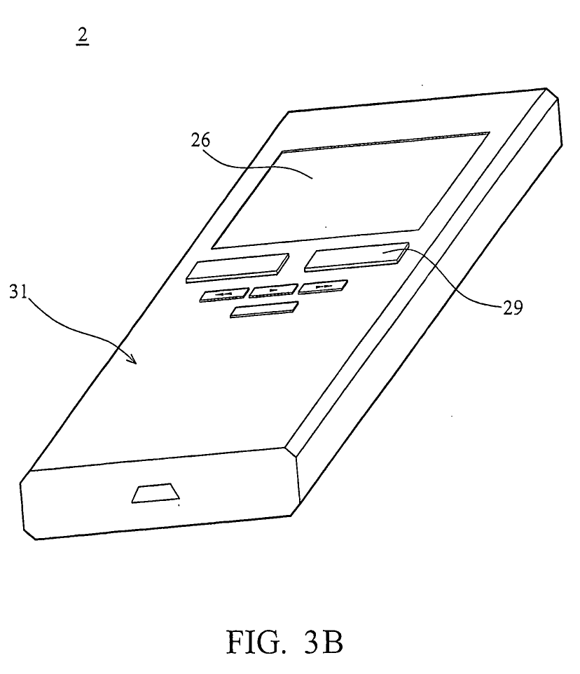

FIG. 2 is a block diagram depicting the operation of an embodiment of the Bluetooth wireless phone 2 of the present invention. FIGS. 3A and 3B are front and rear perspective views of the Bluetooth wireless phone 2 of FIG. 2.

The Bluetooth wireless phone 2 includes a Bluetooth communication module 21, a micro controller unit (MCU) 22, a touchpad 26 and a laser light source 27. The Bluetooth communication module 21 includes a Bluetooth operating unit 211 and a Bluetooth transceiver device 212 which is electrically connected to the Bluetooth operating unit 211. The Bluetooth transceiver device 212 is communicated with electronic equipment 23 having the ability of sending and receiving Bluetooth signals. In this embodiment, the electronic equipment 23 can be a desktop or laptop computer. The Bluetooth operating unit 211 utilizes at least one specific profile, such as a hands-free profile, an advance audio distribution profile, a human-interface operating profile, an audio and video frequency remote control profile or other profiles. The electronic equipment 23 includes a cursor controlled by a corresponding radio wave emitted by the Bluetooth transceiver device 212. The touchpad 26 is electrically connected to the micro controller unit 22, and the micro controller unit 22 is electrically connected to the Bluetooth communication module 21.

In FIGS. 3A and 3B, the Bluetooth wireless phone 2 includes a front surface 30, a rear surface 31 opposite to the front surface 30, a plurality of keys 25 for dialing disposed on the front surface 30, a planar display module 28 disposed on the front surface 30 to display callers or messages, a plurality of hot keys 29 disposed on the rear surface 31, and a touchpad 26 disposed on the rear surface 31. In this embodiment, the planar display module 28 can be a liquid crystal display module, organic light-emitting display module or a light-emitting diode display module. A universal asynchronous receiver and transceiver (UART) or an inter-integrated circuit (I2C) serial bus is utilized to transmit signals between the Bluetooth communication module 21 and the micro controller unit 22. The Bluetooth wireless phone 2 further includes a speaker and a microphone for playing and recording voice data. When the Bluetooth wireless phone 2 is operated, voice data of the administrator and the receiver are played and recorded via the speaker and the microphone, and signal connection is performed between the Bluetooth communication module 21 and the network voice communication software of the electronic equipment 23 so as to perform network voice communications on Internet 24 via the network voice communication software.

In FIG. 3B, by switching an inductive switch of the touchpad 26, the functions of the touchpad 26 are actuated. When the touchpad 26 is touched by a user, an induced plane coordinate is recorded by the touchpad 26. The Bluetooth transceiver device 212 emits a radio wave corresponding to the plane coordinate. By using the human-interface operation profile, the induced plane coordinate is transmitted to the electronic equipment 23 via the Bluetooth transceiver device 212 in the form of radio wave. In FIG. 2, by using the application software provided by the electronic equipment 23, the cursor on the screen of the electronic equipment 23 can be controlled when the electronic equipment 23 receives the radio wave emitted from the Bluetooth wireless phone 2.

Each hot key 29 disposed on the rear surface 31 corresponds to at least one specific profile suitable for video, music or other multimedia. The Bluetooth wireless phone 2 can, for example, receive or transmit high quality stereo audio via the advance audio distribution profile. The Bluetooth wireless phone 2 provide a standard control interface for controlling functions such as “pause”, “stop”, “play” and “volume control” via the audio and video frequency remote control profile.

Except the described functions, the laser light source 27 of the Bluetooth wireless phone 2 is served as a laser pointer for pointing in a commercial brief, thus, the application of the Bluetooth wireless phone 2 is increased.

While the present invention has been described by way of example and in terms of the preferred embodiments, it is to be understood that the present invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A Bluetooth wireless phone, comprising:
a Bluetooth communication module, comprising:
a Bluetooth transceiver device communicating with electronic equipment having an ability of sending and receiving Bluetooth signals; and
a Bluetooth operating unit utilizing at least one specific profile and being electrically connected to the Bluetooth transceiver device;
a micro controller unit electrically connected to the Bluetooth communication module; and
a touchpad electrically connected to the micro controller unit.

2. The Bluetooth wireless phone as claimed in claim 1, further comprising a front surface and a rear surface opposite the front surface.

3. The Bluetooth wireless phone as claimed in claim 2, wherein the touchpad is disposed on the rear surface.

4. The Bluetooth wireless phone as claimed in claim 3, further comprising a plurality of hot keys disposed on the rear surface, wherein each hot key corresponds to the at least one specific profile.

5. The Bluetooth wireless phone as claimed in claim 4, wherein the specific profile is suitable for video, music or other multimedia.

6. The Bluetooth wireless phone as claimed in claim 2, further comprising a planar display module disposed on the front surface.

7. The Bluetooth wireless phone as claimed in claim 6, further comprising a plurality of keys disposed on the front surface.

8. The Bluetooth wireless phone as claimed in claim 7, wherein the keys are suitable for dialing.

9. The Bluetooth wireless phone as claimed in claim 6, wherein the planar display module comprises a liquid display module, an organic light-emitting display module or a light-emitting diode display module.

10. The Bluetooth wireless phone as claimed in claim 1, further comprising a laser light source.

11. The Bluetooth wireless phone as claimed in claim 10, wherein the laser light source is served as a laser pointer.

12. The Bluetooth wireless phone as claimed in claim 1, wherein the touchpad induces and records a plane coordinate.

13. The Bluetooth wireless phone as claimed in claim 12, wherein the Bluetooth transceiver device emits a radio wave corresponding to the plane coordinate.

14. The Bluetooth wireless phone as claimed in claim 13, wherein the electronic equipment comprises a cursor controlled by the radio wave.

15. The Bluetooth wireless phone as claimed in claim 1, further comprising a universal asynchronous receiver and transceiver (UART) to transmit signals between the Bluetooth communication module and the micro controller unit.

16. The Bluetooth wireless phone as claimed in claim 1, further comprising an inter-integrated circuit serial bus to transmit signals between the Bluetooth communication module and the micro controller unit.

17. The Bluetooth wireless phone as claimed in claim 1, wherein the at least one specific profile comprises a hands-free profile, an advance audio distribution profile, a human-interface operation profile, an audio and video frequency remote control profile or other profiles.

18. The Bluetooth wireless phone as claimed in claim 1, wherein the electronic equipment comprises a desktop or laptop computer.

19. The Bluetooth wireless phone as claimed in claim 1, further comprising a speaker/microphone to play/record voice data.

20. The Bluetooth wireless phone as claimed in claim 1, wherein the electronic equipment is incorporated with a network voice communication software, so that a voice communication is performed by the electronic equipment via the network voice communication software.
